(19) United States
(12) Patent Application Publication
(10) Pub. No.: US 2006/0097595 A1
(43) Pub. Date: May 11, 2006

(54) Rotor for an electric motor and corresponding electric motor

(75) Inventor: Andry Randriamanantena, Besancon (FR)

Correspondence Address: DAVIDSON, DAVIDSON & KAPPEL, LLC, 485 SEVENTH AVENUE, 14TH FLOOR, NEW YORK, NY, 10018, US

(73) Assignee: ALSTOM Transport SA, Levallois-Perret (FR)

(21) Appl. No.: 11/243,700

(22) Filed: Oct. 4, 2005

(30) Foreign Application Priority Data
Oct. 5, 2004 (FR) 04 10497
Sep. 14, 2005 (FR) 05 09390

(51) Int. Cl. H02K 21/12

(52) U.S. Cl. 310/156.08

(57) ABSTRACT

This rotor is of the type comprising a plurality of magnetic driving elements (17) which are distributed around the axis of rotation of the rotor, each magnetic driving element (17) defining a magnetic pole of the rotor and having a substantially radial magnetic axis, each magnetic driving element comprising at least one permanent magnet (18).

At least one of the magnetic driving elements (17) comprises a plurality of separate permanent magnets (18), the magnets (18) of the or each magnetic driving element (17) being separated from each other along at least one separation surface which is substantially parallel with the magnetic axis of the or each magnetic driving element (17), and an insulator (55) which is interposed between the magnets (18) of the or each magnetic driving element (17) along the or each separation surface.

The present invention relates to a rotor for an electric motor, of the type comprising a plurality of magnetic driving elements which are distributed around the axis of rotation of the rotor, each magnetic driving element defining a magnetic pole of the rotor, having a substantially radial magnetic axis and comprising at least one permanent magnet.

Rotors of electric motors having permanent magnets comprise permanent magnets which are distributed at the peripheries thereof, each permanent magnet constituting a magnetic pole of the rotor.

During operation, magnetic fluxes which circulate between the permanent magnets extend through the material of the rotor. These magnetic fluxes originate from the permanent magnets themselves and a magnetic field induced by the stator of the electric motor.

Owing to the magnetic fluxes circulating in the rotor, electrical losses may occur, in particular owing to circulation of currents induced in the rotor and the Joule effect.

In order to limit the formation of currents axially in the rotor, it is possible to provide, for example, as in document EP 1 239 569, a rotor which is constituted by a laminated assembly composed of plates which conduct a magnetic field and which are interposed with plates which provide insulation in electromagnetic terms, and to fix the magnets on the periphery of this assembly. The assembly is directly arranged on a shaft.

However, laminated assemblies are costly to produce. This is even more true of high-power rotors having large diameters.

Attempts have been made to design rotors which can, at the same time, be light, rigid and inexpensive to produce.

Document EP 0854 558 describes a rotor which comprises a porous cylindrical element which serves as a hub around which a laminated assembly is arranged, on the periphery of which permanent magnets are arranged. The porous cylindrical element is produced from resin which is charged with powdered iron. In one variant, the porous cylindrical element is produced by a honeycomb structure of metal or resin.

Document EP 1050 946 describes a rotor for a composite electric motor which comprises a steel hub surrounded by an annular element which is constituted by resin and which is itself surrounded by a strip of non-ferromagnetic steel. A laminated assembly surrounds the non-ferromagnetic steel strip and carries magnets on the periphery thereof.

However, these rotors are not entirely satisfactory when the weight and their production cost are set against the limitations of the electromagnetic losses which they allow.

An object of the present invention is to provide an electric motor rotor which allows the electromagnetic losses to be reduced.

To this end, the present invention proposes an electric motor rotor of the above-mentioned type, characterised in that at least one of the magnetic driving elements comprises a plurality of separate permanent magnets, the magnets of the or each magnetic driving element being separated from each other along at least one separation surface which is substantially parallel with the magnetic axis of the or each magnetic driving element, and an electrical insulator which is interposed between the magnets of the or each magnetic driving element along the or each separation surface.

According to specific embodiments, the rotor comprises one or more of the following features, taken in isolation or according to all technically possible combinations:
the insulator covers all the faces of each magnet;
the or each magnetic driving element has at least one separation plane parallel with the axis of the rotor;
the or each magnetic driving element has at least one separation plane perpendicular relative to the axis of the rotor;
the rotor comprises a hub which is provided with a hole for mounting it on a shaft, a rim which surrounds the hub, a laminated assembly which surrounds the rim and which is fixed thereto, the laminated assembly comprising stacked annular plates which conduct a magnetic field, the magnetic driving elements being distributed on the outer periphery of the laminated assembly, and the rim being solid and constituted by a metal or a metal alloy which conducts a magnetic field in order to allow a magnetic flux to extend through the rim, which flux circulates between the magnetic driving elements when an electric motor which is equipped with the rotor is operated;
the hub is solid and is constituted by a metal or a metal alloy which conducts a magnetic field;
the rim is integral with the hub;
the rim and/or the hub are constituted by iron or steel which conducts a magnetic field;
the magnetic driving elements are permanent magnets;
the rim is axially longer than the hub so that the rotor has, at least at one of the axial ends thereof, a central recess which is delimited radially by the rim and axially by the hub;
the hub comprises a central tubular portion and a radial web which radially connects the central tubular portion to the rim;
the central tubular portion is axially longer than the radial web;
the laminated assembly has a radial thickness of between 2 and 100 mm, preferably between 5 and 50 mm;
the ratio of the radial thickness of the laminated assembly and the radial thickness of the hub is between 0.2 and 5;
the ratio of the radial thickness of the laminated assembly and the radial thickness of the rim is between 0.25 and 1;
the thicknesses of the laminated assembly and the rim are selected so that the magnetic field induced by the harmonics circulates in the laminated assembly and the magnetic field induced by the fundamental circulates in the rim and in the laminated assembly; and
the laminated assembly comprises first annular plates which conduct a magnetic field and which are alternated with second annular plates which are constituted by a material which is an electromagnetic insulator.

The invention also relates to an electric motor which comprises a stator and a rotor as defined above.

In one embodiment, the rotor and the stator are received in a housing, the stator being fixedly joined to the housing, the rotor being fixedly joined to a shaft, the motor comprising bearings for guiding in rotation which are arranged between the housing and the shaft, at least one bearing being at least partially received in a recess of the rotor.

The invention will be better understood from a reading of the following description, given purely by way of example and with reference to the appended drawings, in which:

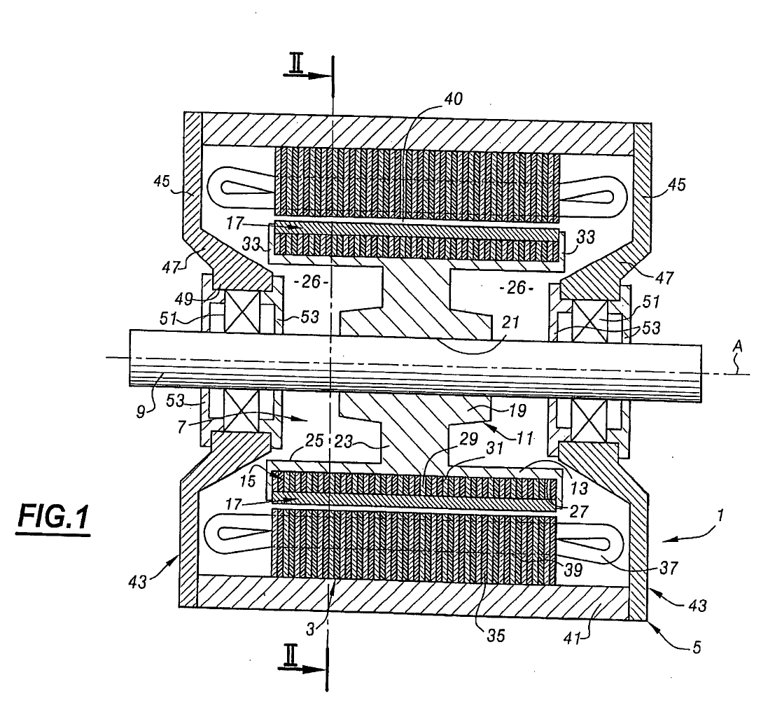

FIG. 1 is an axially sectioned view of an electric motor having permanent magnets comprising a rotor according to the invention;

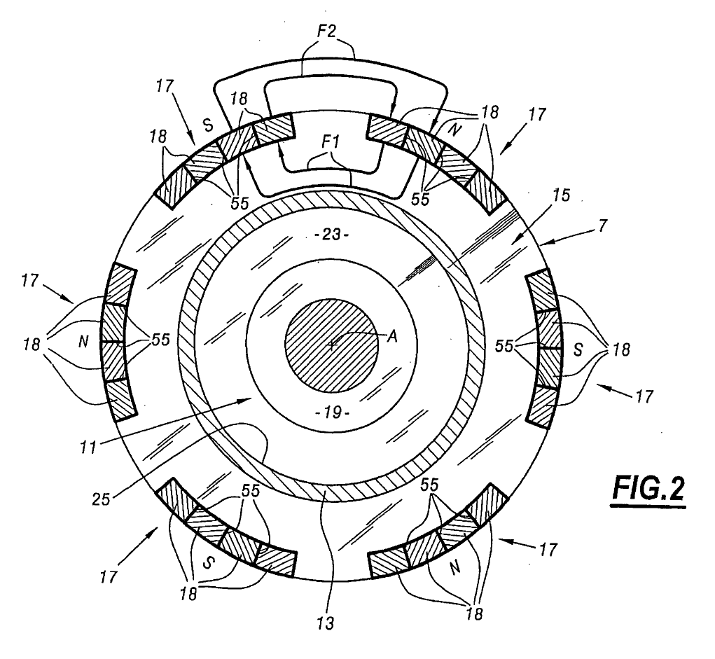

FIG. 2 is a sectioned view along II-II of the rotor of FIG. 1;

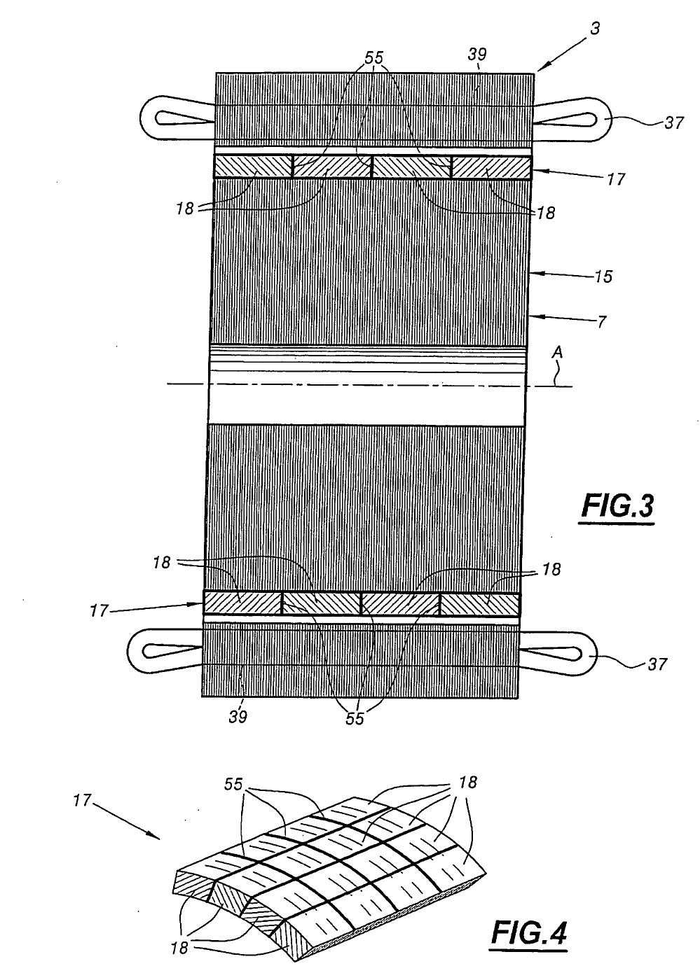

FIG. 3 is similar to FIG. 1 and illustrates a rotor alone, according to one variant of the invention;

FIG. 4 is a perspective view of a magnetic driving element; and

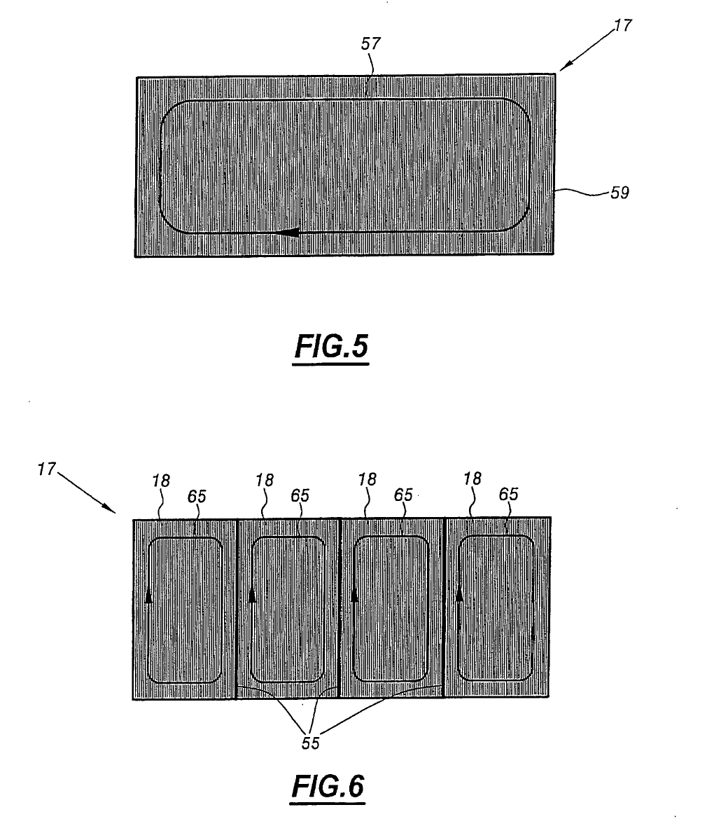

FIGS. 5 and 6 are schematic plan views illustrating Foucault current flows in a magnetic driving element during the operation of the electric motor.

As illustrated in FIG. 1, an electric motor 1 comprises a stator 3 which is fixedly joined to a housing 5 and a rotor 7 which is fixedly joined to a shaft 9.

The rotor 7 comprises a hub 11, a rim 13 which surrounds the hub 11 and which is fixed to the periphery of the hub 11, a cylindrical tubular laminated assembly 15 which surrounds the rim 13 and which is fixed to the rim 13, and magnetic driving elements 17 which are distributed on the outer periphery of the laminated assembly 15.

The hub 11 comprises a tubular central portion 19 which is provided with a hole 21 in which the shaft 9 is received. The hub 11 and the shaft 9 are fixedly joined in rotation using driving means which are not illustrated, such as, for example, keyways. The hub 11 comprises an annular radial web 23 which surrounds the central portion 19 and which extends radially between the central portion 19 and the rim 13. The central portion 19 is axially longer than the radial web 23.

The rim 13 is tubular and cylindrical and has a cylindrical outer surface 27 and inner surface 25.

The rim 13 is axially longer than the radial web 23 and the central portion 19. The rim 13 is consequently connected to the hub 11 only over an axially limited portion of the inner surface 25 of the rim 13.

The rim 13 is, for example, axially centred relative to the hub 11.

Recesses 26 are thus formed at each axial end of the rotor 7. The recesses 26 are delimited radially by the inner surface 25 of the rim 13 and axially by the hub 11.

The laminated assembly 15 is composed of annular plates 29, 31 which are axially stacked. The laminated assembly 15 comprises first plates 29 which conduct a magnetic field and which are alternated with second plates 31 which are constituted by a material which is an electromagnetic insulator.

The laminated assembly 15 is arranged around the rim 13, being fitted on the outer surface 27 thereof.

Preferably, at least the first plates 29 are in contact with the outer surface 27 of the rim 13 by means of the inner edges thereof in order to produce magnetic continuity between these plates 29 and the hub 13.

Axial recesses are, for example, provided in the outer surface of the laminated assembly 15 opposite the rim 13 in order to arrange the magnetic driving elements 17 at that location.

As illustrated in FIG. 2, the magnetic driving elements 17 are, for example, circumferentially regularly spaced and have radial magnetic axes and alternate polarities when viewed along the circumference of the rotor 7. Each magnetic driving element 17 forms a magnetic pole of the rotor 7, that is to say, a region in which the magnetic field lines are concentrated.

The rotor 7 comprises, for example, six magnetic driving elements 17 which are distributed at intervals of 60° around the axis of rotation of the rotor.

Each magnetic driving element 17 comprises a plurality of permanent magnets 18, as will be described in greater detail below.

With reference to FIG. 1, the laminated assembly 15 is axially retained on the rim 13 by means of collars 33 which extend radially outwards from the axial ends of the rim 13. The collars 33 may be attached to the rim 13 or integral with the rim 13 and produced, for example, by means of bending.

The rim 13 is solid and is constituted exclusively by a metal or a metal alloy which conducts a magnetic field, in particular a ferromagnetic metal.

A metal alloy in this instance refers to a metal product which is obtained by incorporating one or more elements in a metal.

A suitable metal is iron which has excellent permeability and magnetic saturation. A metal alloy is, for example, a ferrous alloy, in particular a steel, preferably a soft steel. Possible steel grades are grades C22 to C60 in accordance with the standard EN 10083.

Steel generally has a lower level of permeability and magnetic saturation than does iron, but greater mechanical strength properties.

Advantageously, the hub 11 is also solid and constituted exclusively by a metal or a metal alloy which conducts a magnetic field, in particular a ferromagnetic metal.

In order to limit the production costs of the rotor 7, whilst increasing the strength thereof, the central portion 19, the radial web 23 and the rim 13 are produced as one piece, being integral.

The first plates 29 of the laminated assembly 15 are, for example, also constituted by a metal or a metal alloy which conducts a magnetic field, in particular a ferromagnetic metal, and which is identical to or different from that of the rim 13 and/or the rotor 7.

The ratio between the radial thickness of the laminated assembly 15 and the radial thickness of the rim 13 is, for example, between 0.1 and 5, preferably between 0.25 and 1.

The radial thickness of the laminated assembly 15 is, for example, between 2 and 100 mm, preferably between 5 and 50 mm.

The stator 3 surrounds the rotor 7. The stator 3 comprises a laminated assembly 35 which is similar to the laminated assembly 15 of the rotor 7 but which has an inner diameter which is greater than the outer diameter of the rotor 7. The stator 3 comprises windings 37 which extend axially in the laminated assembly 35 thereof through axial passages 39.

The windings 37 are connected to electrical supply means in a manner not illustrated.

The annular space which is located radially between the laminated assembly 15 of the rotor 7 and the laminated assembly 35 of the stator 3 constitutes the air gap 40 of the motor 1.

The housing 5 comprises a tubular and cylindrical cover 41 which surrounds the stator 3. The stator 3 is fixed to the inner surface of the cover 41.

The housing 5 is axially closed at the ends thereof by means of two annular flanges 43 which are substantially symmetrical relative to a radial centre plane of the electric motor 1.

Each flange 43 comprises a radial annular outer crown 45 and a frustoconical annular inner portion 47 extending, from the zone of the crown 45 having the smallest diameter, radially inwards and axially towards the inner side of the housing 5.

The inner portion 47 of each flange 43 consequently converges in the direction of the other flange 43, towards the inner side of the housing 5.

More precisely, the inner portion 47 of each flange 43 extends axially in the direction of the rotor 7 so that it protrudes partially into the corresponding recess 26.

The inner portion 47 has, in the region of the zone thereof having the smallest diameter, an annular projection 49 which surrounds the shaft 9. Rollers 51 for guiding in rotation are arranged radially between the projection 49 of each flange 43 and the shaft 9.

Sealing means, for example, annular seals 53, are arranged radially between each projection 49 and the shaft 9, axially at each side of the corresponding bearing 51. The seals 53 bring about the sealing between the housing 5 and the shaft 9 in order to prevent the contamination of the inner side of the housing 5.

The bearings 51 and the sealing means 53 carried by the projection 49 are partially received in the corresponding recesses 26. The presence of the recesses 26 thus allows the overall axial spatial requirement of the electric motor 1 to be limited.

During operation, the windings 37 are supplied with electrical energy with an electrical excitation signal which has a specific profile, for example, a periodic profile of the sinusoidal or square type.

The windings 37 create an electromagnetic excitation field which can be adjusted inside the stator 3. The magnetic driving elements 17 to which this electromagnetic excitation field is applied are subjected to circumferentially directed forces. The rotor 7 is consequently driven in rotation about the axis of the shaft 9.

A magnetic flux circulates in the motor 1 of the stator 3 towards the magnetic driving elements 17 through the air gap 40, then between the magnetic driving elements 17 through the first plates 29 of the laminated assembly 15 and the rim 13 (as illustrated by the arrows F1 in FIG. 2), then returns towards the stator 3 via the air gap 40. The magnetic flux circulates in the stator (as illustrated by the arrows F2 in FIG. 2) before returning towards the rotor 7.

Electric currents, of the Foucault current type, have a tendency to form in the rotor 7 owing to the displacement thereof in the electromagnetic field.

These electric currents move principally axially in the rotor 7. The presence of the laminated assembly 15 allows the formation of electric currents of this type to be prevented and consequently limits the electromagnetic losses, in particular the losses owing to the Joule effect.

The periodic excitation signal may be broken down in accordance with the shape thereof into a plurality of sinusoidal signals which comprise a fundamental signal having a greater amplitude and lower frequency and harmonic signals having a lesser amplitude and frequencies which are multiples of the frequency of the fundamental signal.

The electromagnetic field induced in the rotor 7 can, in the same manner, be broken down into an electromagnetic field induced by the fundamental signal and magnetic fields induced by the harmonic signals.

The electromagnetic field induced by the fundamental signal principally allows the rotor 7 to be driven in rotation.

The electromagnetic fields induced by the harmonic signals are the principal cause of the electromagnetic losses.

The depth of radial penetration of the electromagnetic fields induced by each fundamental or harmonic signal is further inversely proportional to the frequency thereof.

The electromagnetic fields induced by the harmonic signals consequently have a penetration depth in the radial thickness of the rotor 7 less than that of the electromagnetic field induced by the fundamental signal.

The radial thickness of the laminated assembly 15 is selected so that, during operation, the thickness thereof is greater than the penetration depth of the electromagnetic fields induced by the harmonic signals.

The radial thickness of the rim 13 is provided so that the radial thickness of the laminated assembly 15 added to that of the rim 13 is greater than the maximum penetration depth of the electromagnetic field induced by the fundamental signal.

The assembly 15 and the rim 13 thus allow the circulation of the magnetic flux of the electromagnetic field induced by the fundamental signal, circumferentially between the magnetic driving elements 17. The laminated assembly 15 ensures the passage of the magnetic flux of the electromagnetic fields induced by the harmonic signals circumferentially between the magnetic driving elements 17 whilst preventing the propagation axially of electric currents resulting from the electromagnetic fields induced by the harmonic signals. This allows the electromagnetic losses resulting from the harmonic signals to be limited.

For example, in a periodic signal of rectangular wave form, the fundamental frequency is equal to that of the signal of rectangular wave form and the first harmonic frequency is five times greater than the fundamental frequency. Consequently, the penetration depth of the electromagnetic field induced by the fundamental signal is five times greater than the penetration depth of the electromagnetic field induced by the first harmonic signal.

It is therefore possible in this instance to provide a laminated assembly 15 which has a radial thickness four times less than that of the rim 13. Generally, the limitation of the radial thickness of the laminated assembly 15 allows the production cost of the rotor 7 to be limited.

The rim 13 which is solid, that is to say, free from cavities and pores, and which is produced entirely from metal or metal alloy which conducts a magnetic field, has a high level of magnetic permeability and magnetic saturation, in contrast to a porous material or a resin, even charged with iron particles. This allows the circuit of the magnetic flux in the rotor 7 to be looped, limiting the resistance to the passage of the magnetic flux in the rotor 7, and an electric motor to be produced which has improved levels of efficiency, in particular in terms of maximum rotation speed and torque which can be transmitted to the shaft 9.

The solid rim 13 is further strong and simple to produce, in contrast, for example, to a material in the form of a honeycomb.

Since the rim 13 is substantially tubular and connected to the hub 11 only over a limited axial region of the inner surface thereof, the rotor 7 is light whilst being strong and allowing the circulation of magnetic fluxes.

The electric motor 1 can be used in applications which require very high levels of torque. For example, the electric motor 1 is used for driving rail vehicles, such as trains or trams.

As can be seen in FIG. 2, each magnetic driving element 17 is segmented and comprises a plurality of permanent magnets 18, for example, four, which are adjacent and separated from each other by an electrical insulator 55 which prevents the circulation of an electric current between the adjacent magnets 18.

More precisely, the magnets 18 of each element 17 are elongate in the axis of rotation of the rotor 7 and are arranged side by side along the circumference of the rotor 7. The magnets 18 of each element 17 are separated from each other along axial planes, that is to say, planes which are parallel with the axis A and which extend through the axis A.

The insulator 55 is arranged between the magnets 18 of each element 17 in the form of films which extend along the separation planes.

The magnets 18 of each element 17 have substantially radial magnetic axes of the same polarity. Each element 17 therefore has a resultant magnetic axis which is radial and which has the same polarity as the magnets 18 which constitute it.

The insulator 55 is interposed along the axial separation planes of the magnets 18, that is to say, planes which are parallel with the magnetic axes of the magnets 18. More precisely, the insulator 55 coats each magnet 18 and covers all the faces of each magnet 18, in particular the faces thereof that are directed radially inwards and outwards.

During operation, the magnetic flux (arrows F1 and F2) extends radially through the magnets 18, in accordance with the magnetic axis thereof. Axial and circumferential induced electric currents relative to the axis A tend to form in the magnets 18 themselves.

The insulator 55 has a small thickness (for example, 20 micrometres), in particular relative to the thickness of an air gap (for example, 5 mm) or the magnets 18 (for example, 10 mm) so that the insulator 55 does not prevent the circulation of the magnetic flux.

Conversely, the insulator 55 naturally opposes the circulation of induced circumferential currents relative to the axis A between the magnets 18 of the same element 17.

Consequently, the electromagnetic losses owing to the Joule effect in the rotor are reduced in the region of the magnets 18.

In the embodiment of FIG. 3, a rotor 7 carries magnetic driving elements 17, each element 17 being segmented along radial separation planes, perpendicular relative to the axis A, and comprising a plurality of magnets 18 which are axially aligned and separated by the insulator 55 which is in the form of films which extend along the radial separation planes.

As illustrated in FIG. 3, the magnetic driving elements 17 are arranged on a rotor 7 which is constituted by a laminated assembly 15. In a variant, the magnetic driving elements 17 are arranged on the rotor 7 of FIG. 1 and more generally on any type of rotor 7.

In a variant, and as illustrated in FIG. 4, an element 17 is segmented along axial separation planes and radial separation planes.

In a variant, the separation between the magnets 18 is carried out along one or more left-hand surfaces.

More generally, the element 17 is segmented along one or more separation surfaces which are parallel with the magnetic axis of the element 17, the surfaces being parallel with each other or not.

On first consideration, the more an element 17 is segmented, the more the electromagnetic losses will be reduced. A rough segmentation already allows a significant reduction, as explained with reference to FIGS. 5 and 6.

In FIG. 5, a loop 57 illustrates a circulation of currents which are induced in a magnetic driving element 58 which is constituted by a unitary permanent magnet 59 whose magnetic axis is perpendicular to the plane of FIG. 5.

In FIG. 6, a magnetic driving element 17 of the same dimensions as the one in FIG. 5, is constituted by a plurality of magnets 18 which are separated along separation planes perpendicular to the plane of FIG. 6, an electrical insulator 55 extending along these separation planes.

The currents induced during operation are propagated along loops 65 in each of the magnets 18.

The sum of the lengths of the loops 65 of FIG. 6 is greater than the length of the single loop 57 of FIG. 5. The currents induced therefore encounter greater resistance to their circulation in the element 17 of FIG. 6 and the induced currents are consequently formed with greater difficulty in the element 17. Consequently, with the same magnetic flux extending through the elements 17 and 58, the currents induced and the losses owing to the Joule effect will be less in the element 17 than in the element 58.

In applications which require a high-power electric motor with a large rotor, the segmentation of the magnetic driving elements further allows small permanent magnets to be used which are less costly to produce.

It will be appreciated that the rotor 7 of FIG. 1 has intrinsic properties in terms of limiting the electromagnetic losses, strength, cost of production and lightness, even when it carries magnetic driving elements which are each in the form of a unitary permanent magnet or a winding.

More generally, an object of the present invention is a rotor comprising a hub which is provided with a hole for mounting it on a shaft, a rim which surrounds the hub, a laminated assembly which surrounds the rim and which is fixed thereto, the laminated assembly comprising stacked annular plates which conduct a magnetic field, the magnetic driving elements being distributed on the outer periphery of the laminated assembly, and the rim being solid and constituted by a metal or a metal alloy which conducts a magnetic field in order to allow a magnetic flux to extend through the rim, which flux circulates between the magnetic driving elements when an electric motor which is equipped with the rotor is operated. The magnetic elements 17 are distributed on the outer periphery of the assembly 15. They are formed by magnets which are, for example, regularly spaced circumferentially and which have alternate polarities. It is not necessary that at least one of the magnetic driving elements comprises a plurality of separate permanent magnets, the magnets of the or each magnetic driving element being separated from each other along at least one separation surface which is substantially parallel with the magnetic axis of the or each magnetic driving element, and an electrical insulator which is interposed between the magnets of the or each magnetic driving element along the or each separation surface.

1-19. (canceled)

20. A rotor for an electric motor, comprising:
a plurality of magnetic driving elements distributed around an axis of rotation of the rotor, each magnetic driving element defining a magnetic pole of the rotor and having a substantially radial magnetic axis, each magnetic driving element including at least one permanent magnet,
at least one of the magnetic driving elements including a further permanent magnet separated from the at least one permanent magnet along at least one separation surface, the at least one separation surface being substantially parallel with the magnetic axis of the at least one magnetic driving element, and including an electrical insulator interposed between the at least one permanent magnet and the further permanent magnet along the at least one separation surface.

21. The rotor according to claim 20 wherein the insulator covers all faces of each of the at least one permanent magnet and the further permanent magnet.

22. The rotor according to claim 20 wherein the at least one magnetic driving element has at least one separation plane parallel with the axis of rotation of the rotor.

23. The rotor according to claim 20 wherein the at least one magnetic driving element has at least one separation plane perpendicular to the axis of rotation of the rotor.

24. The rotor according to claim 20 further comprising a hub provided with a hole for mounting on a shaft, a rim surrounding the hub, and a laminated assembly surrounding the rim and fixed thereto, the laminated assembly including axially stacked annular plates conducting a magnetic field;
the magnetic driving elements being distributed on an outer periphery of the laminated assembly; and
the rim being solid and constituted by a metal or a metal alloy conducting a magnetic field in order to allow a magnetic flux to extend through the rim, a flux of the magnetic field circulating between the magnetic driving elements when an electric motor equipped with the rotor is operated.

25. The rotor according to claim 21 wherein the hub is solid and is constituted by a metal or a metal alloy conducting the magnetic field.

26. The rotor according to claim 25 wherein the rim is integral with the hub.

27. The rotor according to claim 24 wherein the rim and/or the hub are constituted by iron or steel conducting a magnetic field.

28. The rotor according to claim 24 wherein the magnetic driving elements include a plurality of permanent magnets.

29. The rotor according to claim 24 wherein the rim is axially longer than the hub so that the rotor has, at least at one of axial end thereof, a central recess delimited radially by the rim and axially by the hub.

30. The rotor according to claim 24 wherein the hub includes a central tubular portion and a radial web radially connecting the central tubular portion to the rim.

31. The rotor according to claim 30 wherein the central tubular portion is axially longer than the radial web.

32. The rotor according to claim 24 wherein the laminated assembly has a radial thickness of between 2 and 100 mm.

33. The rotor according to claim 32 wherein the laminated assembly has a radial thickness between 5 and 50 mm.

34. The rotor according to claim 24 wherein a ratio of the radial thickness of the laminated assembly and a radial thickness of the hub is between 0.2 and 5.

35. The rotor according to claim 34 wherein the ratio of the radial thickness of the laminated assembly and the radial thickness of the rim is between 0.25 and 1.

36. The rotor according to claim 24 wherein thicknesses of the laminated assembly and the rim are selected so that the magnetic field induced by harmonics circulates in the laminated assembly and the magnetic field induced by a fundamental circulates in the rim and in the laminated assembly.

37. The rotor according to claim 24 wherein the laminated assembly includes annular plates conducting a magnetic field and alternated with second annular plates constituted by a material which is an electromagnetic insulator.

38. An electric motor comprising: a stator and a rotor according to claim 1.

39. The electric motor as recited in claim 38 further comprising a housing and bearings, the rotor and the stator being received in the housing, the stator being fixedly joined to the housing, the rotor being fixedly joined to a shaft, the bearings being arranged between the housing and the shaft for guiding rotation, at least one bearing being at least partially received in a recess of the rotor.
